(19) United States
(12) Patent Application Publication
(10) Pub. No.: US 2012/0176655 A1
(43) Pub. Date: Jul. 12, 2012

(54) OPTICAL READER MODULE AND OPTICAL READER

(75) Inventor: Akira Shirakura, Tokyo (JP)

(73) Assignees: SONY DADC CORPORATION, Tokyo (JP); SONY CORPORATION, Tokyo (JP)

(21) Appl. No.: 13/334,329

(22) Filed: Dec. 22, 2011

(30) Foreign Application Priority Data
Jan. 7, 2011 (JP) 2011-001606

(51) Int. Cl. G03H 1/22

(52) U.S. Cl. 359/32

(57) ABSTRACT

An optical reader module includes a first illumination light source that emits reproducing illumination light to an image-capture target containing a hologram in which information reproduced in a predetermined angle area when illuminated from a predetermined angle is recorded, thereby reproducing the information recorded in the hologram; an image-capturing device that captures an image of the information reproduced from the hologram; and a first light-projecting unit that projects first-optical-guide-forming light on the image-capture target. A first optical guide projected on the image-capture target takes a predetermined shape when the emission angle of the reproducing illumination light to the hologram is equal to the predetermined angle. An observer of the image-capture target recognizes misalignment between the emission angle of the reproducing illumination light to the hologram and the predetermined angle, based on distortion of the first optical guide projected on the image-capture target from the predetermined shape.

### BACKGROUND

The present disclosure relates to optical reader modules and optical readers. More specifically, it relates to optical reader modules and optical readers for holograms containing image information expressed in two dimensions, such as characters and barcodes.

Holograms that can display three-dimensional images are used to authenticate credit cards, identification cards, and the like. In recent years, volume holograms in which interference patterns are recorded as the difference in the index of refraction of recording layers are often used. This is because high level of technology has to be used to produce a recording image to counterfeit volume holograms, and it is difficult to obtain the recording material.

However, the technology to copy volume holograms is advancing day by day, and there is a demand that holograms have better authentication functions and anti-counterfeit features. To impart better authentication functions to holograms, for example, Japanese Unexamined Patent Application Publication No. 2008-122670 discloses an image-switching hologram in which reproduced images are switched depending on the observation direction.

While there is a demand that holograms have better authentication functions, there is another demand for simplified authentication achieved by, for example, making a machine read information recorded in the hologram. For example, there is a demand that holographically recorded information is reproduced, photoelectrically converted by an image-capturing device, and read by a machine.

The image-switching hologram disclosed in Japanese Unexamined Patent Application Publication No. 2008-122670 does not fully meet the demand for simplified authentication, because visual check of a plurality of pieces of recorded image information is inevitable.

### SUMMARY

There is a need for providing an optical reader module and an optical reader that can acquire holographically recorded information.

As a result of intensive study, the present inventors discovered a hologram recording medium with the full width at half maximum (FWHM) of the diffracted light intensity of a reproduced image is controlled. A plurality of pieces of image information can be recorded in this hologram recording medium, and one of the plurality of pieces of recorded image information can be selectively reproduced by, for example, changing the direction of illumination light illuminating the hologram recording medium. Furthermore, the present inventors discovered that, with this hologram recording medium, it is possible to make a machine read image information expressed in two dimensions, such as characters and barcodes, by controlling the angle and distance at which an image is captured.

After further intensive study, the present inventors discovered a hologram reproducing device that emits illumination light in a predetermined direction to selectively reproduce image information recorded in the hologram recording medium, thereby enabling the reproduced image information to be easily, quickly, and reliably observed. With this hologram reproducing device, the direction in which the illumination light illuminating the hologram recording medium is emitted, as well as the observation direction (image-capturing direction), can be controlled. Thus, it is suitable as a tool for capturing images of holograms.

With the thus-discovered hologram recording medium and hologram reproducing device, it is possible to make a machine read characters and barcodes that are holographically recorded. Although the above-described hologram reproducing device is of a stationary type, there is a demand for a hand-held hologram reproducing device that further simplifies reading of holographically recorded image information.

After further intensive study, the present inventors discovered an optical reader module and an optical reader that can acquire holographically recorded character information and bar code information.

An optical reader module according to a preferable embodiment includes a first illumination light source that emits reproducing illumination light to an image-capture target containing a hologram in which at least a piece of information reproduced in a predetermined angle area when illuminated from a predetermined angle is recorded, thereby reproducing the information recorded in the hologram; an image-capturing device that captures an image of the information reproduced from the hologram; and a first light-projecting unit that projects first-optical-guide-forming light on the image-capture target. A first optical guide projected on the image-capture target takes a predetermined shape when the emission angle of the reproducing illumination light to the hologram is equal to the predetermined angle. An observer of the image-capture target recognizes misalignment between the emission angle of the reproducing illumination light to the hologram and the predetermined angle, based on distortion of the first optical guide projected on the image-capture target from the predetermined shape.

An optical reader according to a preferable embodiment includes an illumination light source that emits reproducing illumination light to an image-capture target containing a hologram in which at least a piece of information reproduced in a predetermined angle area when illuminated from a predetermined angle is recorded, thereby reproducing the information recorded in the hologram; an image-capturing unit including an image-capturing device that captures an image of the information reproduced from the hologram; a light-projecting unit that projects optical-guide-forming light to the image-capture target; and a grip that includes a switch for causing the image-capturing unit to start acquisition of the information reproduced from the hologram. An optical guide projected on the image-capture target takes a predetermined shape when the emission angle of the reproducing illumination light to the hologram is equal to the predetermined angle. An observer of the image-capture target recognizes misalignment between the emission angle of the reproducing illumination light to the hologram and the predetermined angle, based on distortion of the first optical guide projected on the image-capture target from the predetermined shape.

It is preferable that the optical reader module or the optical reader includes a second light-projecting unit that emits second-optical-guide-forming light to the image-capture target, in addition to the optical guide for making the observer recognize the misalignment between the emission angle of the reproducing illumination light to the hologram and the predetermined angle. This configuration enables the observer of the image-capture target to recognize whether or not an appropriate distance exists between the image-capturing surface of the image-capturing device and the hologram, based on whether or not the two optical guides projected on the image-capture target overlap each other.

It is preferable that at least one of the angle formed between the normal to the center of the hologram and a straight line connecting the center of the hologram and the first light-projecting unit and the angle formed between the normal to the center of the hologram and a straight line connecting the center of the hologram and the second light-projecting unit be equal to or larger than 15° and be smaller than 90°. With this configuration, the degree of distortion of the optical guide projected on the image-capture target from the predetermined shape can be increased relative to the misalignment between the emission angle of the reproducing illumination light to the hologram and the predetermined angle.

It is preferable that the optical reader module or the optical reader includes a plurality of illumination light sources and that the emission angles of the reproducing illumination light emitted from the plurality of illumination light sources to the image-capture target are different from one another. With this configuration, information recorded in the hologram can be selectively reproduced by switching among the plurality of illumination light sources that emit reproducing illumination light to the image-capture target.

It is preferable that the grip provided in the optical reader is shaped such that the operator can hold with one hand. This configuration improves the ease of operation of the optical reader and allows the information to be easily acquired, even if, for example, the image-capture target is not horizontally placed.

According to preferable embodiments of the optical reader module or preferable embodiments of the optical reader, optical-guide-forming light is emitted to an image-capture target including a hologram, and an optical guide is projected on the image-capture target. Herein, at least a piece of information reproduced in a predetermined angle area when illuminated from a predetermined angle is recorded in the hologram. The optical guide projected on the image-capture target takes a predetermined shape when the emission angle of the reproducing illumination light to the hologram is equal to the predetermined angle. The shape of the optical guide projected on the image-capture target is deformed due to the misalignment between the emission angle of the reproducing illumination light to the hologram and the predetermined angle and is distorted from the predetermined shape. That is, the observer of the image-capture target recognizes misalignment between the emission angle of the reproducing illumination light to the hologram and the predetermined angle, based on the distortion of the optical guide projected on the image-capture target from the predetermined shape.

When the observer of the image-capture target makes the optical guide projected on the image-capture target take a predetermined shape, the positional relationship between the image-capture target and the optical reader module or the optical reader becomes an appropriate positional relationship for acquiring information. If an appropriate positional relationship between the image-capture target and the optical reader module or the optical reader is achieved, the hologram is assuredly illuminated from a predetermined angle, and information recorded in the hologram can be reliably reproduced. Furthermore, the information reproduced from the hologram in a predetermined angle area is reliably incident on the image-capturing device, whereby the information reproduced from the hologram is reliably acquired.

According to at least one of the embodiments, it is possible to provide an optical reader module and an optical reader that can easily, quickly, and reliably acquire holographically recorded information.

### BRIEF DESCRIPTION OF THE DRAWINGS

FIG. 1A is a schematic cross-sectional view showing the configuration of an optical reader module and an optical reader according to a first embodiment, and FIG. 1B shows reading two-dimensional information recorded in a hologram with the optical reader according to the first embodiment;

FIGS. 2A to 2F are schematic diagrams showing the relationship between the projecting angle of optical-guide-forming light and the shape of an optical guide projected on an image-capture target;

FIG. 3A is a schematic cross-sectional view showing the configuration of an optical reader module and an optical reader according to a second embodiment, and FIG. 3B shows reading two-dimensional information recorded in a hologram with the optical reader according to the second embodiment;

FIGS. 4A to 4I are schematic diagrams showing the relationship between the distance between the optical reader and the image-capture target and the shape of the first and second optical guides projected on the image-capture target;

FIGS. 5A to 5I are schematic diagrams showing the relationship between the distance between the optical reader and the image-capture target and the shape of the first and second optical guides projected on the image-capture target when the shape of the second optical guide projected on the image-capture target is maintained constant;

FIG. 6A is a top view schematically showing the configuration of an optical reader module and an optical reader according to a third embodiment, and FIGS. 6B and 6C are schematic diagrams showing the relationship between reproducing illumination light and diffracted light when image information is selectively reproduced from a hologram containing a plurality of pieces of image information to acquire information;

FIG. 7 is a perspective view showing an exemplary configuration of a stationary-type optical reader in which the optical reader module according to the third embodiment is incorporated;

FIG. 8A is a perspective view of an exemplary bar code reader that optically reads a two-dimensional bar code, and

FIG. 8B is a schematic diagram of the bar code reader in FIG. 8A as viewed from the side;

FIG. 9A is a plan view showing the positional relationship between a label on which a one-dimensional bar code is printed and an image-capturing device, FIG. 9B is a schematic diagram for explaining the tilt angle, FIG. 9C is a schematic diagram for explaining the pitch angle, FIG. 9D is a schematic diagram of an exemplary image that appears on a display when the pitch angle is increased, FIG. 9E is a schematic diagram for explaining the skew angle, and FIG. 9F is a schematic diagram showing an exemplary image that appears on the display when the skew angle is increased; and

FIG. 10A is a schematic diagram showing the relationship between reproducing illumination light incident on a hologram containing holographically recorded two-dimensional information and diffracted light, and FIG. 10B is a graph showing the relationship between the standardized intensity of diffracted light expressed as a function of angle β and the full width at half maximum of the reproduction angle of the diffracted light intensity.

### DETAILED DESCRIPTION OF EMBODIMENTS

Embodiments of an optical reader module and an optical reader will be described below in the following sequence: 0. Bar Code Reader and Hologram Containing Two-Dimensional Information

### 1. First Embodiment

### 2. Second Embodiment

### 3. Third Embodiment

### 4. Modification

Note that the embodiments described below are preferable examples of the optical reader module and the optical reader. Although the following description contains various technically preferable limitations, examples of the optical reader module and the optical reader are not limited to the following embodiments unless otherwise specifically stated.

### 0. Bar Code Reader and Hologram Containing Two-Dimensional Information

To facilitate understanding of the embodiments, the configurations of a typical bar code reader and the outline of a hologram in which two-dimensional information is recorded will be described, before giving a description of the embodiments.

### Bar Code Reader

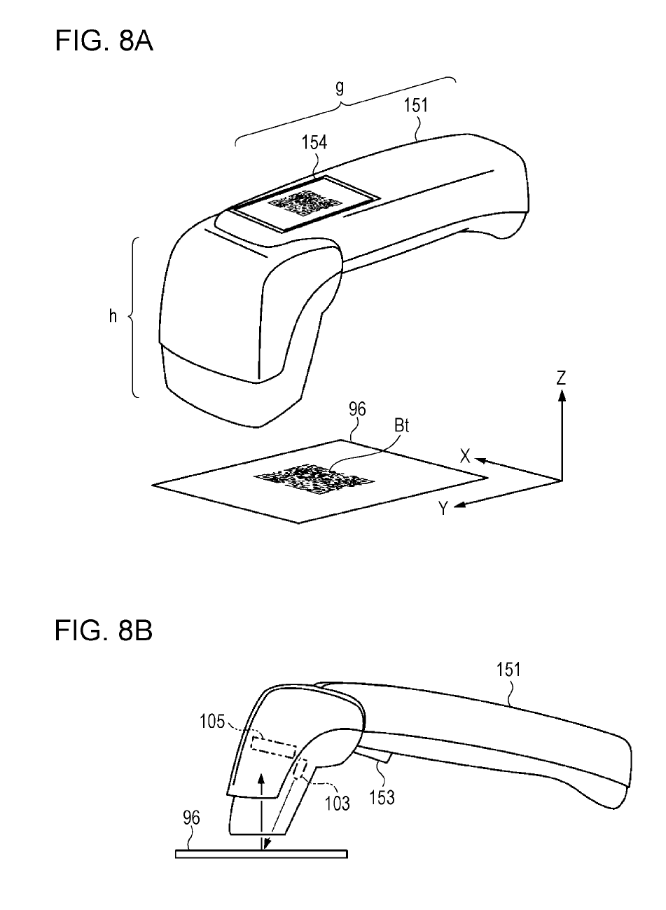

FIG. 8A is a perspective view of an exemplary bar code reader that optically reads a two-dimensional bar code, and FIG. 8B is a schematic diagram of the bar code reader in FIG. 8A as viewed from the side. FIG. 8B does not show an image-forming optical system.

As shown in FIGS. 8A and 8B, a bar code reader 151 includes, for example, a head portion h that captures an image of an image-capture target 96, and a grip g at which an operator holds the bar code reader 151. The grip g has, for example, a trigger switch 153 for instructing the bar code reader 151 to start reading a two-dimensional bar code Bt. A display 154 provided on the bar code reader 151 depending on the necessity displays, for example, an image of the two-dimensional bar code Bt captured by the image-capturing device 105.

The image-capture target 96 shown in FIG. 8A is, for example, a label on which a bar code is printed. The bar code may be directly printed on a package of a product. In such a case, the package of the product serves as the image-capture target. In the example shown in FIG. 8A, the two-dimensional bar code Bt is printed on the surface of the image-capture target 96.

When an operator presses the trigger switch 153, a laser diode 103 is turned on, emitting light and illuminating the two-dimensional bar code Bt. Then, the image-capturing device 105 captures an image of the difference in intensity of light reflected by the two-dimensional bar code Bt, and thus, the information recorded in the two-dimensional bar code Bt is acquired.

In order to acquire the information recorded in the two-dimensional bar code Bt by the bar code reader 151, the head portion h is faced to the two-dimensional bar code Bt such that the light reflected from the two-dimensional bar code Bt is assuredly incident on the image-capturing device 105. When the operator uses the bar code reader 151 held in the operator's hand, the incident angle of the light reflected from the two-dimensional bar code Bt on the image-capturing device 105 rarely agrees with the ideal angle as designed. Therefore, a certain tolerance is allowed for the positional relationship between an image-capturing surface of the image-capturing device 105 and the surface of the image-capture target 96.

The positional relationship between the image-capturing surface of the image-capturing device 105 and the surface of the image-capture target 96 can be expressed by, for example, an angle formed between a straight line C, which is the extension of the normal to the center of the image-capturing surface of the image-capturing device 105 extended so as to pass through the center of the bar code, and a normal N to the center of the bar code. At this time, the positional relationship between the image-capturing surface of the image-capturing device 105 and the surface of the image-capture target 96 can be expressed by, for example, the combination of tilt angle θt, pitch angle θp, and the skew angle θs. Herein, as shown in FIG. 8A, the lateral direction of the image information, e.g., the two-dimensional bar code Bt, on the image-capture target is assumed to be direction X, the longitudinal direction of the two-dimensional bar code Bt, which is perpendicular to direction X, is assumed to be direction Y, and the direction normal to plane XY is assumed to be direction Z.

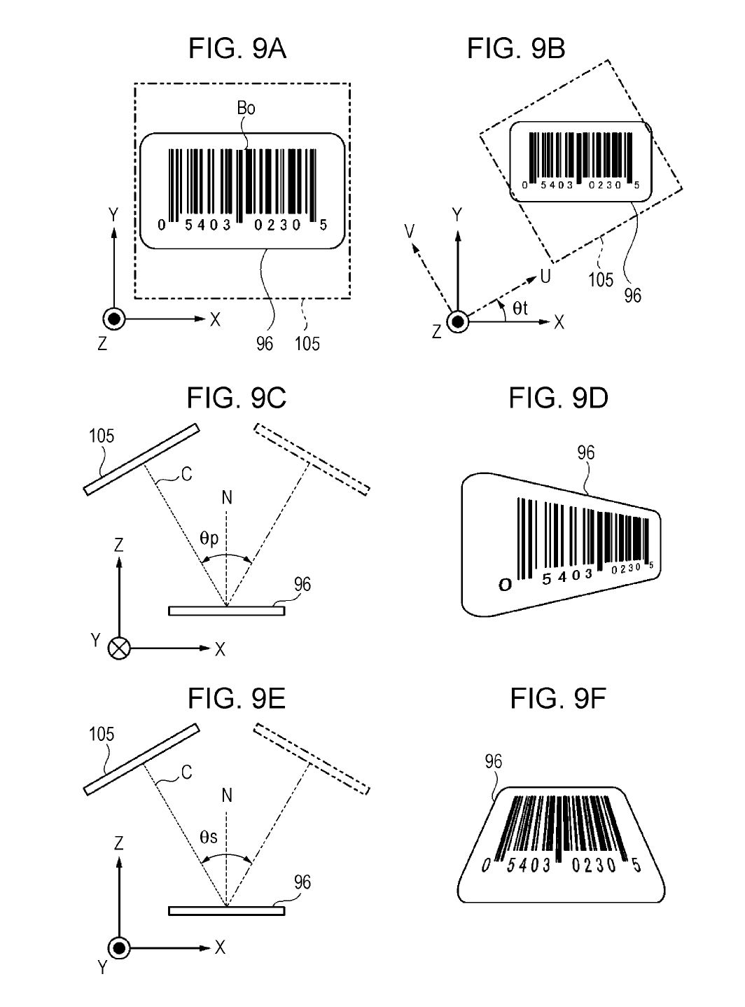

FIG. 9A is a plan view showing the positional relationship between a label on which a one-dimensional bar code is printed and an image-capturing device 105. As shown in FIG. 9A, a one-dimensional bar code Bo is printed on the surface of the image-capture target 96, and the surface of the image-capture target 96 and the image-capturing surface of the image-capturing device 105 are parallel to each other such that the center of the image-capture target 96 and the center of the image-capturing device 105 are aligned. Furthermore, the lateral direction and longitudinal direction of the rectangular image-capturing device 105 correspond to the direction X and the direction Y.

FIG. 9B is a schematic diagram for explaining the tilt angle. As shown in FIG. 9B, tilt angle θt represents the rotation of the bar code Bo and the image-capturing device 105 relative to each other about Z-axis.

FIG. 9C is a schematic diagram for explaining the pitch angle, and FIG. 9D is a schematic diagram of an exemplary image that appears on the display when the pitch angle is increased. As shown in FIG. 9C, pitch angle θp represents the inclination to the left or right of the bar code Bo and the image-capturing device 105 relative to each other.

FIG. 9E is a schematic diagram for explaining the skew angle, and FIG. 9F is a schematic diagram showing an exemplary image that appears on the display when the skew angle is increased. As shown in FIG. 9E, skew angle θs represents the inclination to the front or rear the bar code Bo and the image-capturing device 105 relative to each other.

When a one-dimensional bar code is to be read, the exemplary tolerances allowed for the positional relationship between the image-capturing surface of the image-capturing device 105 and the surface of the image-capture target 96 are: θt: ±15°, θp: ±50° to 70°, and θs: ±50° to 70°.

The positional relationship between the image-capturing surface of the image-capturing device 105 and the surface of the image-capture target 96 can be defined by the distance between the image-capturing surface of the image-capturing device 105 and the surface of the image-capture target 96, in addition to the combination of tilt angle θt, pitch angle θp, and skew angle θs. When reading the bar code, the distance between the image-capturing surface of the image-capturing device 105 and the surface of the image-capture target 96 has to be set such that the bar code can be read. This distance is called a “reading distance” or a “reading depth” and is in the range of about 20 mm to 150 mm. In laser scanners, the larger the distance between the image-capturing surface of the image-capturing device 105 and the surface of the image-capture target 96, the higher resolution is necessary to read the bar code, and hence, it is difficult for the laser scanners to read fine bar codes. Accordingly, in typical bar code readers, the reading distances are determined by the resolutions of the bar code readers.

### Hologram Containing Two-Dimensional Information

Next, the outline of a hologram containing two-dimensional information, devised by the applicants, will be described. Using superimposed recording, a plurality of pieces of image information can be recorded in this hologram. The plurality of pieces of image information recorded in a superimposed manner can be selectively reproduced by, for example, changing the direction in which illumination light illuminates the hologram. Herein, the term “two-dimensional information” refers to image information expressed in two dimensions, such as characters and barcodes. Examples of the two-dimensional information include characters, numbers, signs, figures, patterns, one-dimensional bar codes, two-dimensional bar code, and any combination of them.

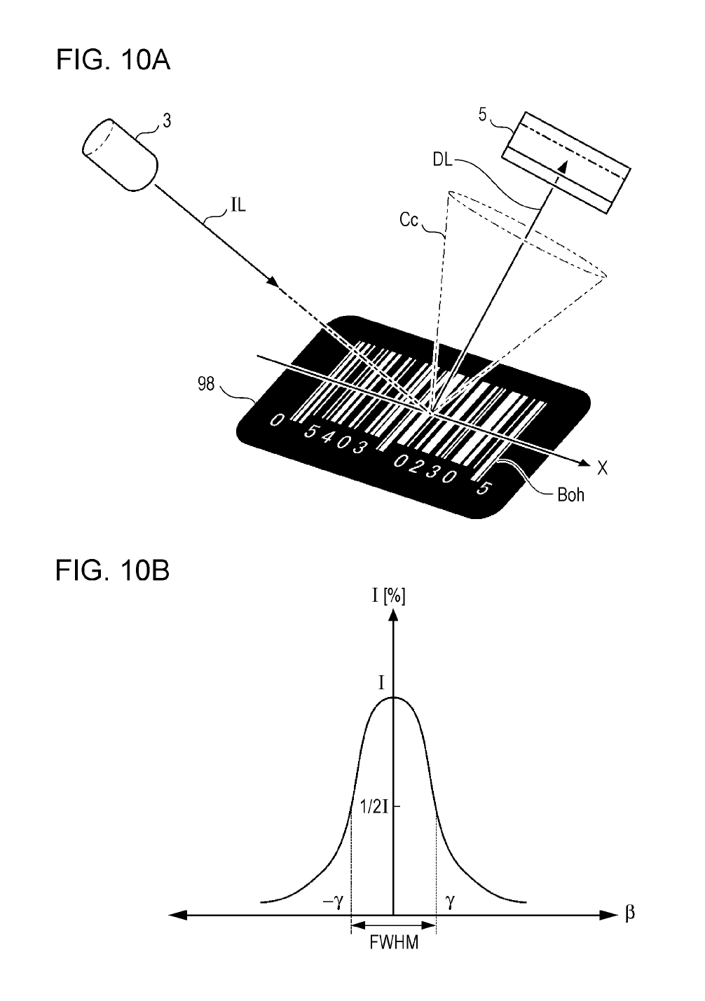

FIG. 10A is a schematic diagram showing the relationship between reproducing illumination light incident on a hologram containing holographically recorded two-dimensional information and diffracted light. For example, a one-dimensional bar code Boh is holographically recorded as two-dimensional information in a hologram 98 shown in FIG. 10A. The recording medium of the hologram containing the two-dimensional information is, for example, a volume hologram in which an interference pattern is recorded as the difference in the index of refraction of the inside of a recording layer. In FIG. 10A, arrow DL schematically represents the direction in which the diffracted light intensity from the hologram 98 is maximum, when reproducing illumination light IL from a dedicated illumination light source 3 is incident on the hologram 98. Furthermore, cone Cc schematically represents the area in which the holographically recorded one-dimensional bar code Boh can be observed, when the reproducing illumination light IL from the dedicated illumination light source 3 is incident on the hologram 98.

It is possible to adjust the angle of view in which the two-dimensional information is observed when the hologram 98 is observed, by adjusting the diffusion angle of object light with which the two-dimensional information is superimposed in the process of holographically recording two-dimensional information. Herein, by recording the two-dimensional information with the object light having a reduced diffusion angle at the image-forming optical system so as to narrow the angle of view of the two-dimensional information observed on the hologram 98, the reproduced image of the two-dimensional information can be made bright and sharp.

When recording two-dimensional information, the two-dimensional information is directly located at a very shallow depth from the recording surface of the hologram 98. If the two-dimensional information is located at a large distance from the recording surface of the hologram 98, upon illumination of the hologram 98 with a diffusion light source, superimposed images are reproduced. This degrades the sharpness of the reproduced image and makes it difficult to make a machine read the two-dimensional information. Note that the depth at which the two-dimensional information is located can be flexibly selected, depending on what image processing is to be performed, the position of a diffuser, or the like.

FIG. 10B is a graph showing the relationship between the standardized intensity of diffracted light expressed as a function of angle β and the full width at half maximum of the reproduction angle of the diffracted light intensity. Herein, angle β represents the angle formed between the direction in which the diffracted light intensity from the hologram 98 is maximum and the direction in which the hologram 98 is observed. The full width at half maximum of the reproduction angle of the diffracted light intensity refers to the angle area obtained by doubling the angle that is half the maximum value, when the diffracted light intensity is expressed as a function of angle β. In the example shown in FIG. 10B, the diffracted light intensity I is half the maximum value at angle ±γ. Thus, the full width at half maximum is 2γ. In the hologram 98 in which two-dimensional information is recorded with object light with the diffusion angle being controlled, 2γ is equal to or smaller than 8°.

Herein, in order to observe the two-dimensional information recorded in the hologram 98 with a narrow angle of view of the reproduced image, an appropriate combination of the direction normal to the hologram, the direction of reproducing illumination light illuminating the hologram, and the direction in which the hologram is observed has to be selected. For example, in order to make a machine read holographically recorded two-dimensional information, the hologram 98 has to be assuredly illuminated from a predetermined angle, so that the hologram 98 reliably reproduces the recorded two-dimensional information and so that the diffracted light from the hologram 98 reliably enters an image-capturing device 5. In other words, in order to make a machine read holographically recorded two-dimensional information, the dedicated illumination light source 3, the hologram 98, and the image-capturing device 5 have to have an appropriate positional relationship.

Typically, information in two-dimensional bar codes can be acquired at any tilt angle θt. Therefore, tilt angle θt does not seem to be a problem when recording a two-dimensional bar code, instead of the one-dimensional bar code Boh. However, in order to reproduce a holographically recorded two-dimensional bar code, an appropriate direction of the reproducing illumination light has to be selected. As has been described, in the process of holographically recording two-dimensional information, the diffusion angle of the object light at the image-forming optical system is narrow. Thus, when the dedicated illumination light source 3 is incorporated in an optical reader, such as a bar code reader, to illuminate the hologram 98 and read holographically recorded two-dimensional information, the tolerance of tilt angle θt is smaller than that of typical bar code readers.

Furthermore, the full width at half maximum of the reproduction angle of the diffracted light intensity of the hologram 98 is smaller than the typical tolerances of the pitch angle θp and skew angle θs. Therefore, in order to acquire holographically recorded two-dimensional information with an optical reader, such as a bar code reader, it is desirable that an operator of the optical reader be able to determine whether or not an appropriate positional relationship exists between the optical reader and the image-capture target.

There have been hand-held bar code readers that project an optical guide on an image-capture target with light or a laser beam emitted from a light-emitting diode (LED) to help an operator aim a bar code. However, such an optical guide is for helping the operator aim the position provided with the bar code and is not for making the operator intuitively understand the inclination of the bar code reader. This is because such a bar code reader has relatively large tolerances of tilt angle θt, pitch angle θp, and skew angle θs (i.e., several tens of degrees), and the inclination of the bar code reader is not a serious problem when reading a printed bar code.

### 1. First Embodiment

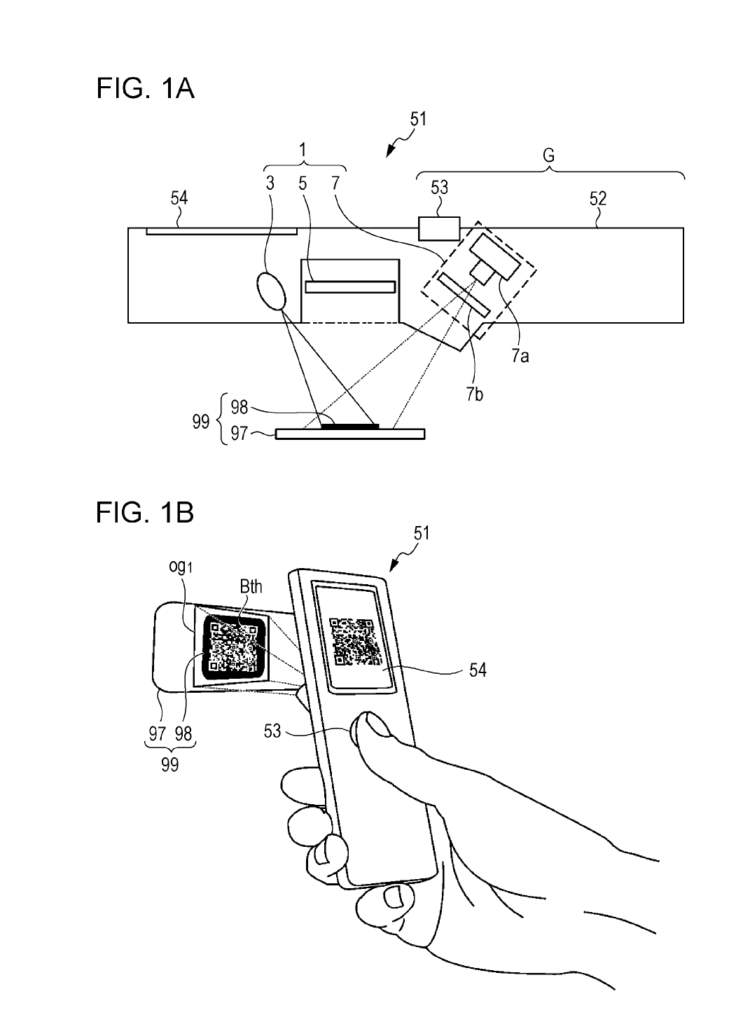

FIG. 1A is a schematic cross-sectional view showing the configuration of an optical reader module and an optical reader according to a first embodiment, and FIG. 1B shows reading two-dimensional information recorded in a hologram with the optical reader according to the first embodiment.

As shown in FIG. 1A, in the first embodiment, an optical reader module 1 includes the dedicated illumination light source 3, the image-capturing device 5, and a first light-projecting unit 7. The optical reader module 1 is accommodated in, for example, a case 52 and is used as an optical reader 51 to read information recorded in a hologram. An operator of the optical reader 51 holds the optical reader 51 at a grip G shown in FIG. 1A, which is shaped such that the operator can hold with one hand. The grip G has a switch 53 for starting acquisition of information reproduced from the hologram 98. A display 54 provided on the optical reader 51 depending on the necessity displays the results of the instruction given to the optical reader 51 and the content of the information acquired. Note that FIG. 1A does not show an image-forming optical system disposed between an image-capture target 99 and the image-capturing device 5 or an image-processing unit that processes images captured by the image-capturing device 5.

Although FIG. 1A shows a configuration in which the image-capture target 99 is formed of an adherend 97 and the hologram 98 bonded thereto, the image-capture target 99 may of course be formed only of the hologram 98. Two-dimensional information, such as a two-dimensional bar code Bth, is recorded in the hologram 98. Examples of the adherend 97 include a product, a package of a product, and an identification card provided with the hologram 98, and are not specifically limited.

The dedicated illumination light source 3, the image-capturing device 5, and the first light-projecting unit 7 will be described below in sequence.

### Dedicated Illumination Light Source

The dedicated illumination light source 3 illuminates the hologram 98 contained in the image-capture target 99 from a predetermined direction to make the hologram 98 reproduce the recorded information. Examples of the dedicated illumination light source 3 include an LED light source, a fluorescent lamp, a halogen lamp, a xenon lamp, a krypton lamp, and an electro-luminescence (EL) light source. A fluorescent excitation LED may be used as the LED light source. Alternatively, light guided through an optical fiber or the like may be used as the dedicated illumination light source 3.

It is preferable that the dedicated illumination light source 3 illuminate the entire region in the hologram 98 where the two-dimensional information is recorded. By doing so, the entire two-dimensional information recorded in the hologram 98 is brightly reproduced, enabling the reproduced two-dimensional information to be read at once. A diffuser or a collimating lens may be disposed in a line connecting the dedicated illumination light source 3 and the center of the hologram 98, so that the entire two-dimensional information recorded in the hologram 98 is brightly reproduced. Alternatively, a reflective plate may be disposed on the opposite side of the hologram 98 with respect to the dedicated illumination light source 3, or the dedicated illumination light source 3 may be formed as a group of a plurality of light sources.

The reproducing illumination light emitted from the dedicated illumination light source 3 to the hologram 98 and a laser beam used to record information in the hologram 98 do not have to have the same wavelength. As long as the reproducing illumination light contains a wavelength component of the laser beam used to record information in the hologram 98, the information recorded in the hologram 98 can be reproduced.

When an image is captured in the direction normal to the surface of the hologram 98, the emission angle of the reproducing illumination light is preferably such that the angle formed between the straight line connecting the center of the hologram 98 and the dedicated illumination light source 3 and the normal to the center of the hologram 98 is in the range from 10° to 35°. With this configuration, the dedicated illumination light source 3 and the image-capturing device 5 can be disposed so as not to interfere with each other, and the size of the optical reader module 1 can be reduced.

### Image-Capturing Device

The image-capturing device 5 receives light diffracted and emitted from the hologram 98 irradiated with the reproducing illumination light from the dedicated illumination light source 3, performs photoelectrical conversion, and outputs the difference in intensity of the diffracted light as an electric signal. Examples of the image-capturing device 5 include devices such as a charge-coupled device (CCD) and a complementary metal-oxide semiconductor (CMOS). Of course, the image-capturing device 5 is not limited thereto.

As will be described below, the image-capturing device 5 is disposed such that the diffracted light from the hologram 98 is assuredly incident on the image-capturing device 5. Note that the image-capturing device 5 is disposed in the case 52 so as not to receive the reproducing illumination light from the dedicated illumination light source 3, first-optical-guide-forming light from a first light-projecting unit 7 (described below), or light totally reflected at the surface or the back surface of the hologram 98.

### First Light-Projecting Unit

The first light-projecting unit 7 is a light source for projecting the first-optical-guide-forming light on the image-capture target 99. More specifically, the first light-projecting unit 7 includes, for example, an optical-guide-forming light source 7a and a filter 7b.

Examples of the optical-guide-forming light source 7a include an LED light source and a semiconductor laser. The filter 7b is an optical device disposed to diffuse the light emitted from the optical-guide-forming light source 7a and project the light as an optical guide having a predetermined shape on the image-capture target 99. Examples of such an optical device include a diffraction optical device and a refraction optical device. Instead of the optical-guide-forming light source 7a and filter 7b pair, a scanning optical system may be used to project an optical guide on the image-capture target 99.

As shown in FIG. 1B, the light emitted from the optical-guide-forming light source 7a passes through the filter 7b and forms an optical guide og₁ having a predetermined shape on the image-capture target 99. Although the shape of the optical guide og₁ projected on the image-capture target is, for example, rectangular, the shape of the optical guide og₁ is of course not limited thereto.

The optical guide og₁ projected on the image-capture target 99 makes an operator understand whether or not an appropriate positional relationship for reading two-dimensional information reproduced from the hologram 98 exists between the optical reader 51 and the image-capture target 99. In other words, the optical guide og₁ makes an operator understand whether or not an appropriate positional relationship for reading two-dimensional information reproduced from the hologram 98 exists among the dedicated illumination light source 3, the hologram 98, and the image-capturing device 5.

The optical guide og₁ projected on the image-capture target 99 takes, for example, a square shape when the emission angle of the reproducing illumination light emitted from the dedicated illumination light source 3 is appropriate for reproducing the two-dimensional information recorded in the hologram 98. This makes it easy for an operator to intuitively recognize deformation of the optical guide og₁ projected on the image-capture target 99, when the emission angle of the reproducing illumination light is shifted from an appropriate angle for reproducing the two-dimensional information recorded in the hologram 98.

Accordingly, the shape of the optical guide og₁ is not limited to square, but may be any shape as long as it can make the operator intuitively recognize deformation of the optical guide og₁ projected on the image-capture target 99 from a preset shape, e.g., square. For example, if the preset shape is square, a shift of the emission angle of the reproducing illumination light from an appropriate angle for reproducing the two-dimensional information recorded in the hologram 98 causes the shape of the optical guide og₁ projected on the image-capture target to be continuously deformed from square to trapezoid.

Examples of the preset shape include square, polygonal, circular, and cross shapes. When the preset shape is circular, for example, a portion of the circle may be replaced by a straight line or cut away so that a shift of the tilt angle θp can be recognized. In this manner, when projected on the image-capture target, the optical guide og₁ does not have to be continuous, but, for example, only four corners of the square may be projected. Alternatively, the optical guide og₁ may be formed by projecting a group of dots or a group of line segments on the image-capture target, or the above-described shapes may be combined.

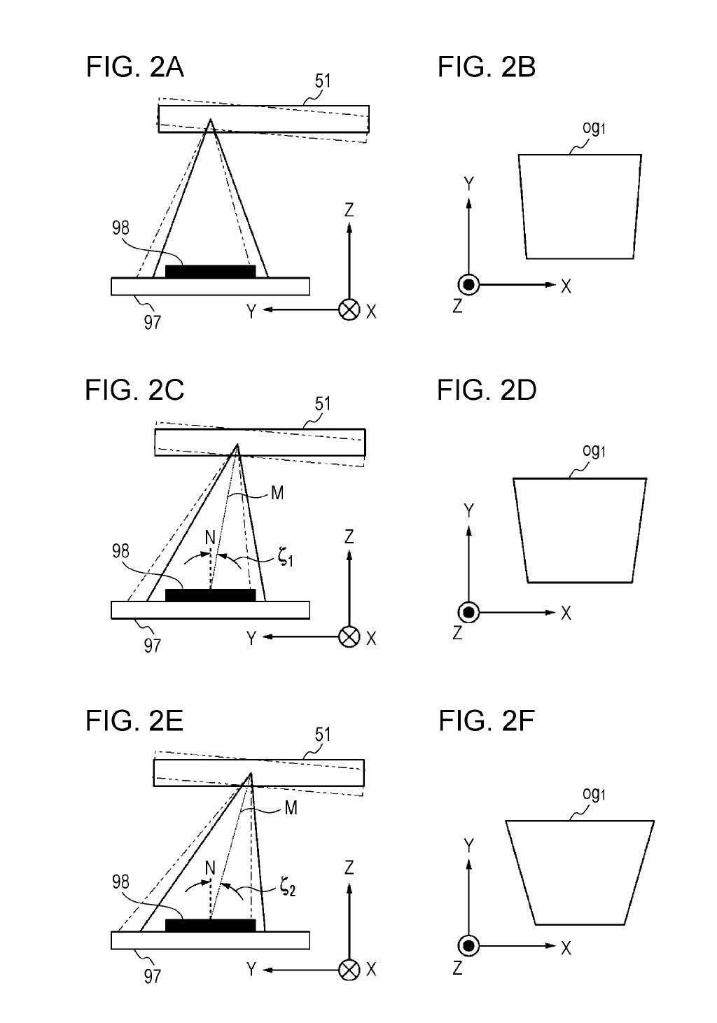

FIGS. 2A to 2F are schematic diagrams showing the relationship between the projecting angle of the optical-guide-forming light and the shape of the optical guide projected on the image-capture target. In order to make an operator recognize a shift of the emission angle of the reproducing illumination light from an appropriate angle for reproducing the two-dimensional information, the degree of change in shape of the optical guide og₁ projected on the image-capture target is preferably large relative to the shift of the emission angle of the reproducing illumination light. In FIGS. 2A to 2F, it is assumed that the optical guide og₁ projected on the image-capture target is square when the emission angle of the reproducing illumination light emitted from the dedicated illumination light source 3 is appropriate for reproducing the two-dimensional information recorded in the hologram 98.

FIG. 2A shows a case where the first light-projecting unit 7 is disposed in the direction normal to the hologram 98, and a skew angle is given to the optical reader 51. The shape of the optical guide og₁ projected on the image-capture target at this time is not square but trapezoid, as shown in FIG. 2B.

FIG. 2C shows a case where the same skew angle as that in FIG. 2A is given to the optical reader 51, assuming that the angle formed between normal N to the center of the hologram 98 and straight line M connecting the center of the hologram 98 and the first light-projecting unit 7 is τ₂. The shape of the optical guide og₁ projected on the image-capture target at this time is shown in FIG. 2D. FIG. 2E shows a case where the same skew angle as that in FIG. 2A is given to the optical reader 51, assuming that the angle formed between normal N to the center of the hologram 98 and straight line M connecting the center of the hologram 98 and the first light-projecting unit 7 is ξ₂. The shape of the optical guide og₁ projected on the image-capture target at this time is shown in FIG. 2F. Herein, 0°<ξ₁<ξ₂<90°.

As shown in FIGS. 2A to 2F, if the skew angle given to the optical reader 51 is the same, the larger the angle formed between normal N to the center of the hologram 98 and straight line M connecting the center of the hologram 98 and the first light-projecting unit 7, the more significantly the optical guide og₁ is distorted. Although FIGS. 2A to 2F show examples in which the same skew angle is given to the optical reader 51, the same results are obtained when the same pitch angle is given to the optical reader 51.

Accordingly, it is preferable that the optical-guide-forming light is projected on the image-capture target in an oblique direction and that the angle formed between the straight line connecting the center of the hologram and the first light-projecting unit and the normal to the center of the hologram be in the range from 15° to 90°. At this time, by correcting the trapezoidal distortion (the keystone distortion) in advance, the optical guide og₁ can take a preset shape when the emission angle of the reproducing illumination light is appropriate for reproducing the two-dimensional information.

As described above, the shape of the optical guide og₁ projected on the image-capture target is, for example, square, when the emission angle of the reproducing illumination light emitted from the dedicated illumination light source 3 is appropriate for reproducing the two-dimensional information recorded in the hologram 98. At this time, the direction in which the diffracted light intensity from the hologram 98 is maximum is aligned with the direction in which the diffracted light from the hologram 98 is incident on the image-capturing surface of the image-capturing device 5. That is, the diffracted light from the hologram 98 is assuredly incident on the image-capturing device 5, when the shape of the optical guide og₁ projected on the image-capture target is square.

According to the first embodiment, an operator of the optical reader 51 can determine whether or not an appropriate positional relationship exists between the image-capture target and the optical reader 51, from the distortion of the optical guide projected on the image-capture target. Furthermore, by making the optical guide projected on the image-capture target have a shape close to the preset shape, the positional relationship between the image-capture target and the optical reader 51 can be adjusted to an appropriate positional relationship for acquiring information. Thus, the operator of the optical reader 51 can assuredly illuminate the hologram 98 from a predetermined angle, making the hologram 98 reliably reproduce the recorded information, and can acquire the information by pressing the switch 53. By making the diffracted light from the hologram 98 reliably incident on the image-capturing device 5, major changes to existing software and algorithms becomes unnecessary.

### 2. Second Embodiment

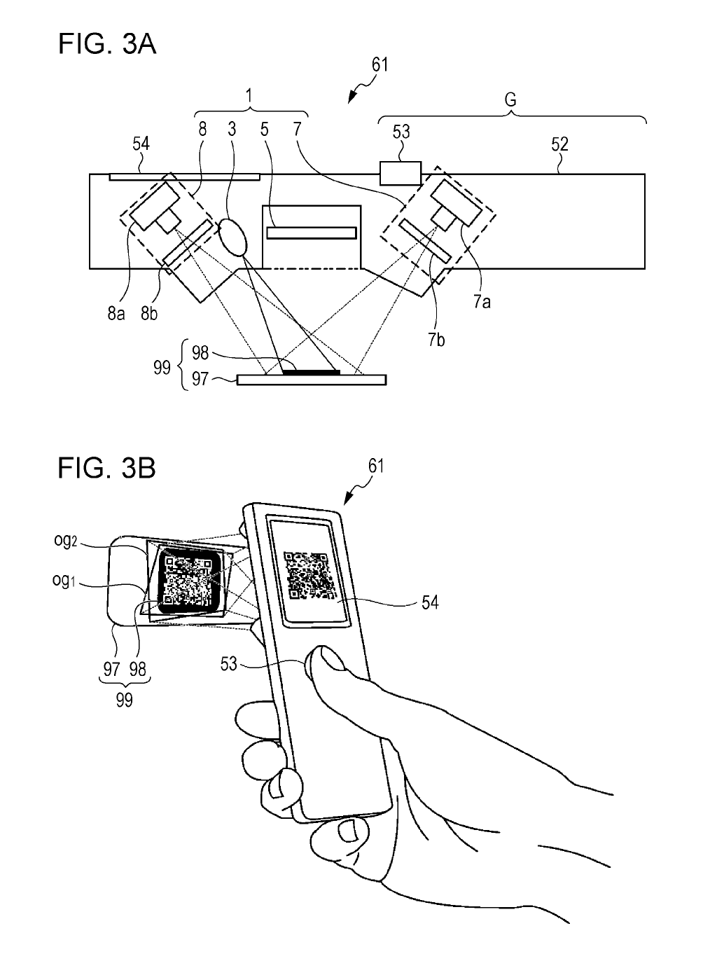

FIG. 3A is a schematic cross-sectional view showing the configuration of an optical reader module and an optical reader according to a second embodiment, and FIG. 3B shows reading two-dimensional information recorded in a hologram with the optical reader according to the second embodiment.

As shown in FIG. 3A, in the second embodiment, an optical reader module 11 further includes a second light-projecting unit 8 composed of an optical-guide-forming light source 8a and a filter 8b, in addition to the dedicated illumination light source 3, the image-capturing device 5, and the first light-projecting unit 7. Thus, compared with the optical reader according to the first embodiment, an optical reader 61 according to the second embodiment further includes the second light-projecting unit 8 composed of the optical-guide-forming light source 8a and the filter 8b. The configurations of the optical-guide-forming light source 8a and the filter 8b may be the same as those of the optical-guide-forming light source 7a and the filter 7b. FIG. 3A does not show the image-forming optical system disposed between the image-capture target 99 and the image-capturing device 5, or the image-processing unit that processes an image captured by the image-capturing device 5.

As shown in FIG. 3B, in the second embodiment, a second optical guide og₂ formed by second-optical-guide-forming light emitted from the second light-projecting unit 8 is projected on the image-capture target 99, in addition to the first optical guide og₁. Although FIG. 3B shows an example in which the shape of the second optical guide og₂ projected on the image-capture target is rectangular, the shape of the second optical guide og₂ is not limited thereto.

The second optical guide og₂ projected on the image-capture target makes an operator understand whether or not an appropriate reading distance for reading two-dimensional information reproduced from the hologram 98 exists between the optical reader 61 and the image-capture target 99. In other words, the second optical guide og₂ makes the operator understand whether or not an appropriate reading distance for reading the two-dimensional information reproduced from the hologram 98 exists between the image-capturing surface of the image-capturing device 5 and the surface of the image-capture target 99. If the distance between the optical reader 61 and the image-capture target 99 is inappropriate, a region containing no two-dimensional information is illuminated, or only a limited portion of the region containing the two-dimensional information is brightly reproduced, making it difficult to read the recorded two-dimensional information at once.

The second optical guide og₂ projected on the image-capture target is designed to take a predetermined shape when the emission angle of the reproducing illumination light emitted from the dedicated illumination light source 3 is appropriate for reproducing the two-dimensional information recorded in the hologram 98. Herein, examples of the shape of the second optical guide og₂ include square, as in the case of the first optical guide og₁. The predetermined shape of the second optical guide og₂ may be either the same as or different from that of the first optical guide og₁. For example, one of the optical guides may be square, and the other of the optical guides may have only four corners.

The second optical guide og₂ projected on the image-capture target is designed to overlap the first optical guide og₁, when the distance between the optical reader 61 and the image-capture target 99 is the appropriate reading distance for reproducing the two-dimensional information recorded in the hologram 98. That is, an operator of the optical reader 61 can determine whether or not an appropriate distance exists between the image-capturing surface of the image-capturing device 5 and the surface of the image-capture target 99, based on whether or not the two optical guides projected on the image-capture target overlap each other.

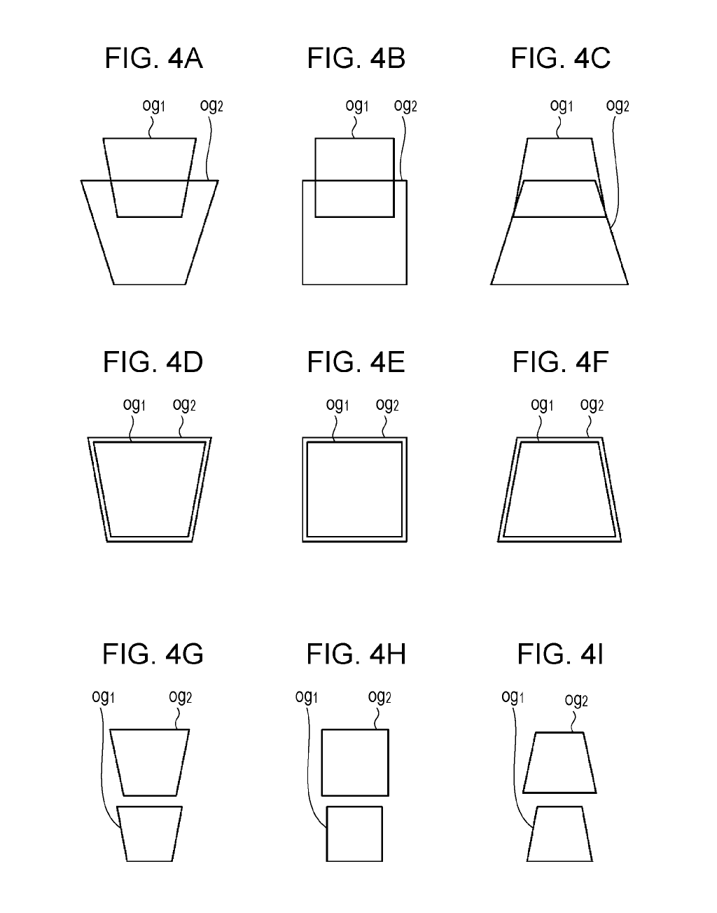

FIGS. 4A to 4I are schematic diagrams showing the relationship between the distance between the optical reader and the image-capture target and the shape of the first and second optical guides projected on the image-capture target.

FIGS. 4A to 4C show cases in which the distance between the optical reader and the image-capture target is larger than the appropriate reading distance. FIG. 4A shows a case in which a positive skew angle is given to the optical reader 61, and FIG. 4C shows a case in which a negative skew angle is given to the optical reader 61. In none of the cases, the first optical guide og₁ and the second optical guide og₂ overlap each other.

FIGS. 4D to 4F show cases in which the distance between the optical reader and the image-capture target is the appropriate reading distance. In FIGS. 4D to 4F, the sizes of the first optical guide og₁ and second optical guide og₂ are slightly differentiated for the ease of explanation.

In FIG. 4E, the first optical guide og₁ and the second optical guide og₂ have a predetermined shape, for example, square, and overlap each other. That is, FIG. 4E shows a case in which an appropriate positional relationship, in terms of both angle and distance, exists between the image-capture target and the optical reader 61. On the other hand, FIG. 4D shows a case in which a positive skew angle is given to the optical reader 61, and FIG. 4F shows a case in which a negative skew angle is given to the optical reader 61. In these cases, although the first optical guide og₁ and the second optical guide og₂ overlap each other, the shapes of the first optical guide og₁ and second optical guide og₂ are not square but trapezoid. Thus, in these cases, the operator of the optical reader 61 can recognize that the positional relationship between the image-capture target and the optical reader 61 is appropriate in terms of the distance, whereas it is appropriate in terms of the angle.

FIGS. 4G to 4I show cases in which the distance between the optical reader and the image-capture target is smaller than the appropriate reading distance. FIG. 4G shows a case in which a positive skew angle is given to the optical reader 61, and FIG. 4I shows a case in which a negative skew angle is given to the optical reader 61. In none of the cases, the first optical guide og₁ and the second optical guide og₂ overlap each other.

When the second light-projecting unit 8 is provided in addition to the first light-projecting unit 7, it is preferable that the diffusion angle at which light emitted from the optical-guide-forming light source 7a is diffused and the diffusion angle at which light emitted from the optical-guide-forming light source 8a is diffused be differentiated. Alternatively, it is preferable that the projecting angle of first-optical-guide-forming light and the projecting angle of second-optical-guide-forming light be differentiated. By doing so, the change in the shape of the optical guide projected on the image-capture target can be differentiated between the first optical guide og₁ and the second optical guide og₂. Note that at least one of the first-optical-guide-forming light and the second-optical-guide-forming light may be projected perpendicularly on the image-capture target.

The light emitted from the optical-guide-forming light source 7a and the light emitted from the optical-guide-forming light source 8a may have different wavelengths. In such a case, the color of the first optical guide og₁ projected on the image-capture target is different from that of the second optical guide og₂. Thus, the operator of the optical reader 61 can distinguish the first optical guide og₁ from the second optical guide og₂ projected on the image-capture target.

Furthermore, the second light-projecting unit 8 may be configured to maintain the same orientation with respect to the inclination of the optical reader 61. By doing so, even when the optical reader 61 is inclined, the projecting angle of the second-optical-guide-forming light with respect to the image-capture target can be maintained constant, whereby the shape of the second optical guide og₂ projected on the image-capture target can be maintained constant.

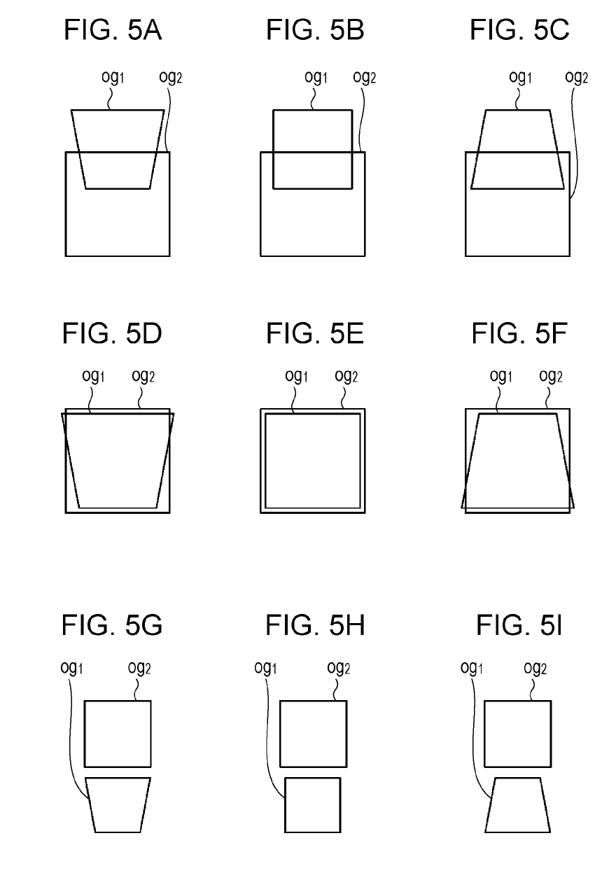

FIGS. 5A to 5I are schematic diagrams showing the relationship between the distance between the optical reader and the image-capture target and the shape of the first and second optical guides projected on the image-capture target when the shape of the second optical guide og₂ projected on the image-capture target is maintained constant. FIGS. 5A to 5C show cases in which the distance between the optical reader and the image-capture target is larger than the appropriate reading distance. FIGS. 5D to 5F show cases in which the distance between the optical reader and the image-capture target is the appropriate reading distance. FIGS. 5G to 5I show cases in which the distance between the optical reader and the image-capture target is smaller than the appropriate reading distance. In FIGS. 5D to 5F, the sizes of the first optical guide og₁ and second optical guide og₂ are slightly differentiated for the ease of explanation.

As shown in FIG. 5A to 5I, when the shape of the second optical guide og₂ projected on the image-capture target is maintained constant, the two optical guides overlap each other only when the positional relationship between the image-capture target and the optical reader 61 is appropriate in terms of both angle and distance.

According to the second embodiment, the operator of the optical reader 61 can recognize the distortion of the two optical guides projected on the image-capture target and whether or not the two optical guides projected on the image-capture target overlap each other. Thus, the operator of the optical reader 61 can determine whether or not an appropriate positional relationship exists between the image-capture target and the optical reader 61.

### 3. Third Embodiment

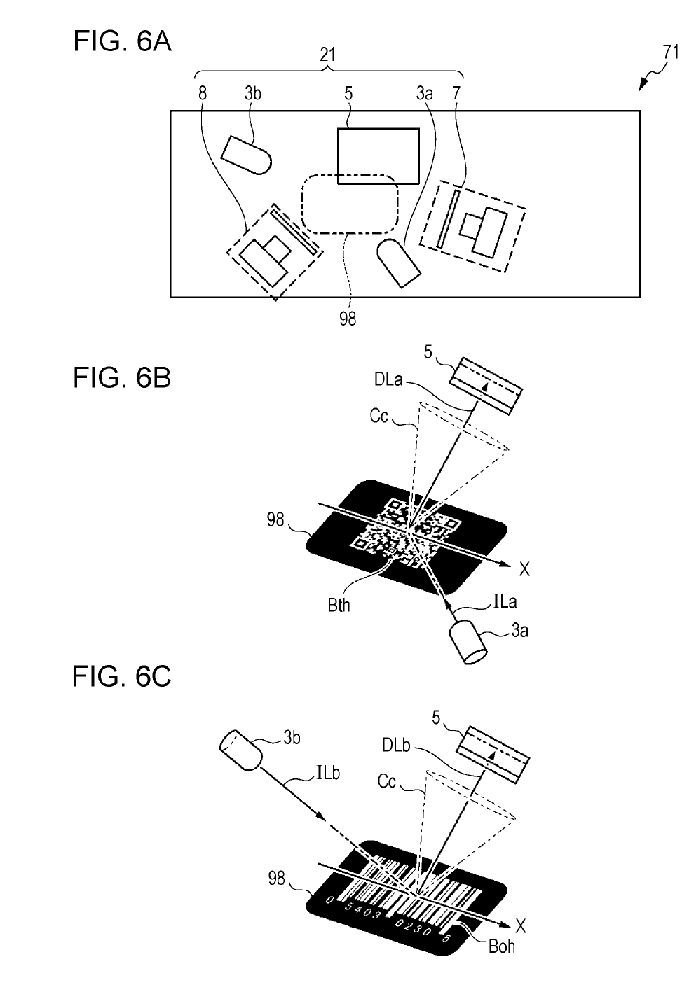

FIG. 6A is a top view schematically showing the configuration of an optical reader module and an optical reader according to a third embodiment, and FIGS. 6B and 6C are diagrams showing reading of individual two-dimensional information from a hologram in which a plurality of pieces of two-dimensional information are recorded.

As shown in FIG. 6A, in the third embodiment, an optical reader module 21 includes a plurality of light sources for illuminating a hologram. More specifically, for example, the optical reader module 21 includes dedicated illumination light sources 3a and 3b, the image-capturing device 5, the first light-projecting unit 7, and the second light-projecting unit 8. Thus, compared with the optical reader 61 according to the second embodiment, an optical reader 71 according to the third embodiment includes, for example, two dedicated illumination light sources. These dedicated illumination light sources, for example, the dedicated illumination light sources 3a and 3b, are disposed so as to emit the reproducing illumination light to the image-capture target from different angles. Note that the number of dedicated illumination light sources is not limited to two.

As described above, the hologram 98 may contain a plurality of pieces of image information. The optical reader module 21 and the optical reader 71 according to the third embodiment selectively reproduce the image information recorded in the hologram 98 to acquire the information.

FIGS. 6B and 6C are schematic diagrams showing the relationship between reproducing illumination light and diffracted light, when image information is selectively reproduced from a hologram containing a plurality of pieces of image information to acquire information. In the examples shown in FIGS. 6B and 6C, for example, a two-dimensional bar code Bth and a one-dimensional bar code Boh are recorded in the hologram 98 in a superimposed manner. For example, by changing the direction of the reproducing illumination light illuminating the hologram 98, one of the plurality of pieces of image information recorded in the hologram 98 can be selectively reproduced.

The hologram 98 that can selectively reproduce one of the plurality of pieces of image information can be fabricated by differentiating the emission angle of the reference light used to record the two-dimensional bar code Bth from the emission angle of the reference light used to record the one-dimensional bar code Boh, during recording of the image information in the hologram 98. As shown in FIG. 6B, for example, when only the dedicated illumination light source 3a is turned on to emit reproducing illumination light ILa to the hologram 98, the two-dimensional bar code Bth is reproduced from the hologram 98. Diffracted light DLa of the two-dimensional bar code Bth reproduced from the hologram 98 is incident on the image-capturing device 5. Furthermore, as shown in FIG. 6C, for example, when only the dedicated illumination light source 3b is turned on to emit reproducing illumination light ILb to the hologram 98, the one-dimensional bar code Boh is reproduced from the hologram 98. Diffracted light DLb of the one-dimensional bar code Boh reproduced from the hologram 98 is incident on the image-capturing device 5.

According to the third embodiment, because the optical reader module 21 and the optical reader 71 according to the third embodiment include a plurality of dedicated illumination light sources, it is possible to selectively reproduce the image information from the hologram 98 containing a plurality of pieces of image information. Furthermore, the selectively reproduced image information can be acquired.

It is preferable that the optical reader module 21 and the optical reader 71 have a control circuit and a switch for switching on and off of the plurality of dedicated illumination light sources. When acquiring a plurality of pieces of image information, the plurality of dedicated illumination light sources may be sequentially turned on, so that the selectively reproduced image information can be shot continuously. Thus, a plurality of pieces of image information can be acquired. If the operator makes an appropriate positional relationship between the image-capture target and the optical reader 71 based on the shapes of the two optical guides projected on the image-capture target, a plurality of pieces of image information can be automatically acquired by a continuous shooting function, without causing any stress to the operator. When the plurality of pieces of image information recorded in the hologram 98 are associated with each other, the acquired image information may be checked against each other.

### Modification to Third Embodiment

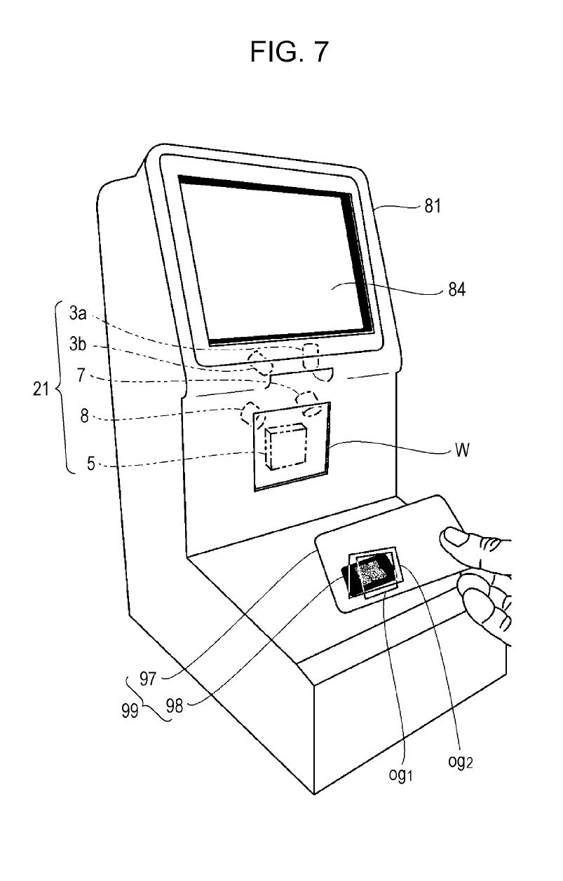

FIG. 7 is a perspective view showing an exemplary configuration of a stationary-type optical reader in which the optical reader module according to the third embodiment is incorporated. As shown in FIG. 7, the optical reader module 21 according to the third embodiment is incorporated in an optical reader 81. Furthermore, for example, the optical reader 81 has a display 84 provided on the front side thereof, which indicates the instruction to the optical reader 81, results of the instruction, and the acquired information. The display 84 may be a touch-panel display that can be used as an operation panel. When a credit card 99 composed of, for example, a magnetic card 97 and the hologram 98 attached thereto is exposed to the front side of the optical reader 81, the optical reader 81 acquires image information recorded in the hologram 98.

The first-optical-guide-forming light and the second-optical-guide-forming light from the first light-projecting unit 7 and the second light-projecting unit 8, respectively, are emitted to the credit card 99, serving as the image-capture target. Thus, the first optical guide og₁ and the second optical guide og₂ are projected on the credit card 99. The holder of the credit card 99 can achieve an appropriate positional relationship between the credit card 99 and the optical reader 81 by adjusting the inclination of the credit card 99.

When an appropriate positional relationship for acquiring information is achieved between the credit card 99 and the optical reader 81, for example, the dedicated illumination light sources 3a and 3b sequentially emit reproducing illumination light, and the diffracted light from the hologram 98 enters the image-capturing device 5 through a window W. At this time, because the angle of view of the two-dimensional information reproduced from the hologram 98 is narrow, a risk of the two-dimensional information recorded in the hologram 98 being viewed by another person is low.

### 4. Modification

Although preferred embodiments have been described, the preferred examples are not limited to the above-described embodiments. For example, the dedicated illumination light source may be formed of a scanning optical system, or the optical reader module may have an auto-focus function. Furthermore, for example, a data-transmission unit may be provided to enable transmission of the acquired information between an information terminal and a server.

Furthermore, for example, the optical reader module may be incorporated into electronic equipment, such as a portable information terminal (personal digital assistance (PDA)), a cell phone, a smartphone, an electronic organizer, and a laptop computer, or it may be used as a removable attachment in combination with electronic equipment.

Although the case has a substantially rectangular parallelepiped shape in the above-described embodiments, the shape of the case is not limited thereto. For example, the optical reader may be configured as a handgun-shaped optical reader. The grip G may have any shape as long as it can be held by one hand. The grip G may have a handle shape, or the grip G may be provided with a belt. Furthermore, for example, a numeric keypad for giving an instruction to the optical reader may be provided on the grip G. For safety's sake, a switch for starting projection of optical-guide-forming light may be provided separately from a switch for starting acquisition of information. Furthermore, for example, the display may be configured as a touch-panel display that can be used as an operation panel.

Furthermore, in the above-described embodiments, although the back surface of the optical reader is faced to the image-capture target, and the reproducing illumination light is emitted from the back surface of the optical reader, the configuration is not limited thereto. For example, the side surface of the optical reader may be faced to the image-capture target.

In the above-described second and third embodiments, whether or not an appropriate distance exists between the optical reader and the image-capture target can be determined based on whether or not the first and second optical guides projected on the image-capture target overlap each other. However, the configuration is not limited to this example. For example, whether or not an appropriate the distance exists between the optical reader and the image-capture target may be determined based on whether or not the first optical guide projected on the image-capture target overlaps a guide mark, which is recorded on the image-capture target by printing or the like in advance. Alternatively, the outline of the hologram may be used as the guide mark.

According to at least one embodiment, holographically recorded information can be easily, quickly, and reliably acquired. Therefore, the optical reader module and the optical reader can be applied not only to a bar code reader, but also to a scanner, an optical character reader (OCR), an optical mark reader (OMR), a seal or stamp recognition device, a fingerprint identification device, a money identification device, or a combination of these devices.

The present disclosure contains subject matter related to that disclosed in Japanese Priority Patent Application JP 2011-001606 filed in the Japan Patent Office on Jan. 7, 2011, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An optical reader module comprising:
a first illumination light source that emits reproducing illumination light to an image-capture target containing a hologram in which at least a piece of information reproduced in a predetermined angle area when illuminated from a predetermined angle is recorded, thereby reproducing the information recorded in the hologram;
an image-capturing device that captures an image of the information reproduced from the hologram; and
a first light-projecting unit that projects first-optical-guide-forming light on the image-capture target,
wherein a first optical guide projected on the image-capture target takes a predetermined shape when the emission angle of the reproducing illumination light to the hologram is equal to the predetermined angle, and
wherein an observer of the image-capture target recognizes misalignment between the emission angle of the reproducing illumination light to the hologram and the predetermined angle, based on distortion of the first optical guide projected on the image-capture target from the predetermined shape.

2. The optical reader module according to claim 1, further comprising a second light-projecting unit that emits second-optical-guide-forming light to the image-capture target,
wherein the observer of the image-capture target recognizes whether or not an appropriate distance exists between an image-capturing surface of the image-capturing device and the hologram, based on whether or not the first optical guide and the second optical guide projected on the image-capture target overlap each other.

3. The optical reader module according to claim 2,
wherein at least one of the angle formed between the normal to the center of the hologram and a straight line connecting the center of the hologram and the first light-projecting unit and the angle formed between the normal to the center of the hologram and a straight line connecting the center of the hologram and the second light-projecting unit is equal to or larger than 15° and is smaller than 90°.

4. The optical reader module according to claim 1, further comprising at least one illumination light source different from the first illumination light source,
wherein the emission angles of the reproducing illumination light emitted to the image-capture target from the plurality of illumination light sources, including the first illumination light source, are different from one another, and
wherein the information recorded in the hologram is selectively reproduced by switching among the plurality of illumination light sources, including the first illumination light source, that emit the reproducing illumination light to the image-capture target.

5. An optical reader comprising:
an illumination light source that emits reproducing illumination light to an image-capture target containing a hologram in which at least a piece of information reproduced in a predetermined angle area when illuminated from a predetermined angle is recorded, thereby reproducing the information recorded in the hologram;
an image-capturing unit including an image-capturing device that captures an image of the information reproduced from the hologram;
a light-projecting unit that projects optical-guide-forming light to the image-capture target; and
a grip that includes a switch for causing the image-capturing unit to start acquisition of the information reproduced from the hologram,
wherein an optical guide projected on the image-capture target takes a predetermined shape when the emission angle of the reproducing illumination light to the hologram is equal to the predetermined angle, and
wherein an observer of the image-capture target recognizes misalignment between the emission angle of the reproducing illumination light to the hologram and the predetermined angle, based on distortion of the first optical guide projected on the image-capture target from the predetermined shape.

6. The optical reader according to claim 5,
wherein the grip is shaped such that the operator can hold with one hand.
